(19) United States
(12) Patent Application Publication
(10) Pub. No.: US 2010/0309770 A1
(43) Pub. Date: Dec. 9, 2010

(54) Optical head device and optical information recording/reproducing device

(75) Inventor: Ryuichi Katayama, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/311,864

(22) PCT Filed: Nov. 9, 2007
(86) PCT No.: PCT/JP2007/071782

§ 371 Date: Apr. 16, 2009

(30) Foreign Application Priority Data
Nov. 16, 2006 (JP) 2006-310778

(51) Int. Cl. G11B 7/135

(52) U.S. Cl. 369/112.03; G9B/7.112

(57) ABSTRACT

To provide an optical head device and an optical information recording/reproducing device for recording/reproducing a signal on/from an optical recording medium having two recording layers without generating the disturbance on the track error signal detected with differential push-pull method even if the interval between the target layer and the non-target layer changes. The light beam emitted from a semiconductor laser is divided into a zeroth order main beam and a positive and a negative first order diffracted light sub-beams by a diffractive optical element. The light beams are applied onto a disk by an objective lens. The reflected light beam of the main beam and reflected light beams of the sub-beams from the disk are received by a photodetector. From the output of the photodetector, a differential push-pull signal is calculated, and used as a track error signal. The sub-beams become Laguerre-Gauss beams by the diffractive optical element.

### TECHNICAL FIELD

The present invention relates to an optical head device and an optical information recording/reproducing device to record/reproduce information on/from an optical recording medium having two or more of the recording layers. Note that the optical information recording/reproducing device according to the invention includes both recording/reproducing device that records/reproduces information on/from the optical recording medium and a reproduction-only device that only reproduces information from the optical recording medium.

### BACKGROUND ART

On each of write-once type optical recording media, such as a DVD-R and an HD DVD-R, and rewritable type optical recording media, such as a DVD-RW and an HD DVD-RW, a groove is formed as an information track. The optical head device and the optical information recording/reproducing device that records/reproduces information on/from an optical recording medium have a function of detecting a track error signal which indicates a positional shift of a light focusing spot from the information track in order to position the light focusing spot which is formed on the optical recording medium to follow the information track. As a method for detecting the track error signal, a push-pull method is generally used for the write-once type optical recording medium and the rewritable type optical recording medium.

However, in a case of detecting the track error signal with the push-pull method, when an objective lens of an optical head device shifts in a direction perpendicular to the information track in order to follow the information track, a large offset is generated. This offset is called an offset by a lens shift, and it causes deterioration in a recording/reproducing characteristic. As a method to detect the track error signal without generating the offset by the lens shift, a differential push-pull method has been known (Patent Documents 1-3).

A related optical head device shown in FIG. 10 has a function to detect the track error signal with the differential push-pull method. In FIG. 10, an emitted light beam from a semiconductor laser is collimated by a collimate lens 2, and divided into three light beams, that is, a zeroth order light beam which is a main beam, and a positive and a negative first order diffracted light beams which are sub-beams, by a diffractive optical element 3d. These light beams make incident as P-polarized light beams to a polarization beam splitter 4, and almost all of which transmit therethrough. These light beams then transmit a quarter wavelength plate 5, which are converted from linearly polarized light to circularly polarized light, and converged onto a disk 7 by an objective lens 6.

The reflected light beam of the main beam and the reflected light beams of the sub-beams from the disk 7 transmit through the objective lens 6 in the reverse direction and transmit through the quarter wavelength plate 5 to be converted from the circularly polarized light to the linearly polarized light whose polarization direction is orthogonal to that of the light on the incoming way. Further, these light beams make incident to the polarization beam splitter 4 as S-polarized light, and almost all of which are reflected, then transmit through a cylindrical lens 8 and a convex lens 9 to be received by a photodetector 10.

The diffractive optical element 3d is configured in such a manner that a plurality of diffraction gratings 20 whose cross-sectional shapes are rectangular are formed on a surface of a substrate 20. Grooves of the gratings of the diffraction grating 20 are in parallel to a radial direction of the disk 7, and the pattern of the gratings is in a linear form of an equivalent pitch. About 87.6% of the light beam making incident on the diffractive optical element 3d transmits as the zeroth order light beam, and about 5% each is diffracted as the positive and negative first order diffracted light beams. Here, a circle illustrated with a dotted line in the drawing corresponds to an effective diameter 22 of the objective lens 6.

FIG. 12 shows a layout of the light focusing spots on the disk 7. The light focusing spots 16a, 16d, and 16e correspond to the zeroth order light beam, to the positive first order diffracted light beam, and to the negative first order diffracted light beam from the diffractive optical element 3d, respectively. The light focusing spot 16a of the main beam is converged on a track 15a. On the other hand, the light focusing spot 16d of the sub-beam is converged on a middle point between the track 15a and a neighboring track 15b located on the right side of the track 15a, and the light focusing spot 16e of the sub-beam is converged on a middle point between the track 15a and a neighboring track 15c located on the left side of the track 15a.

FIG. 13 shows a pattern of light receiving sections in the photodetector 10 and a layout of optical spots on the photodetector 10. The photodetector 10 is arranged at a middle point between two focal lines of a lens system configured with the cylindrical lens 8 and the convex lens 9.

The optical spot 17a corresponds to the zeroth order light beam from the diffractive optical element 3d, and is formed on light receiving sections 19a-19d which are divided into four by a dividing line corresponding to the radial direction of the disk 7 (i.e. a direction perpendicular to the information track) and by a dividing line corresponding to the tangential direction of the disk 7 (i.e. a direction parallel to the information track).

The optical spot 17b corresponds to the positive first order diffracted light beam from the diffractive optical element 3d, and is formed on light receiving sections 19e and 19f which are separated into two by a dividing line corresponding to the radial direction of the disk 7.

The optical spot 17c corresponds to the negative first order diffracted light beam from the diffractive optical element 3d, and is formed on light receiving sections 19g and 19h which are separated into two by a dividing line corresponding to the radial direction of the disk 7.

The light intensity distribution in a direction corresponding to the radial direction of the disk 7 and the light intensity distribution in a direction corresponding to the tangential direction of the disk 7 are switched each other in the optical spots 17a-17c compared to the light beam which is yet to be made incident into the lens system, because of the effects of the lens system configured with the cylindrical lens 8 and the convex lens 9. The optical spot 18 will be described later.

Levels of the voltage signals outputted from the light receiving sections 19a-19h are expressed as V19a-V19h, respectively. Then, a push-pull signal by the main beam (MPP) can be obtained by an arithmetic operation of MPP=(V19a+V19b)−(V19c+V19d), and a push-pull signal by the sub-beam (SPP) can be obtained by an arithmetic operation of SPP=(V19e+V19g)−(V19f+V19h). The differential push-pull signal (DPP) used as a track error signal can be obtained by an arithmetic operation of DPP=MPP−K*SPP (K is a constant).

Patent Document 1: Japanese Unexamined Patent Publication 2004-288227

Patent Document 2: Japanese Unexamined Patent Publication 2006-236581

Patent Document 3: Japanese Unexamined Patent Publication 2006-252619

### DISCLOSURE OF THE INVENTION

### Problems to be Solved by the Invention

The optical recording media such as the DVD-R, the HD DVD-R, the DVD-RW, and the HD DVD-RW include the optical recording medium having two recording layers. In a case of using the optical recording medium having two recording layers, when a main beam and sub-beams are converged onto a target layer that is a layer on/from which information is recorded/reproduced, a part of the reflected light beam of the main beam from a non-target layer (on/from which information is not recorded/reproduced) makes incident as disturbance light to a light receiving section for receiving the sub-beams reflected from the target layer.

An optical spot 18 shown in FIG. 13 corresponds to the reflected light beam of the main beam from the non-target layer, and it is found that a part of the reflected light beam of the main beam makes incident to light receiving sections 19e-19h as the disturbance light. Since the optical spot 18 spreads widely on a photodetector 10, a proportion of the disturbance light in the optical spot 18 is small. However, since a light amount of the optical spot 18 of the main beam is larger than a light amount of optical spots 17b and 17c of the sub-beams, a light amount of the disturbance light is unignorable compared to the light amount of optical spots 17b and 17c. At this time, the disturbance light interferes with the optical spot 17b on the light receiving sections 19e and 19f, and the disturbance light interferes with the optical spot 17c on the light receiving sections 19g and 19h.

In this case, when an interval between the target layer and the non-target layer is changed, a phase difference between the disturbance light and the optical spots 17b and 17c is changed. If the phase difference between the disturbance light and the optical spots 17b and 17c is brought closer to zero, the light intensity on the light receiving sections 19e-19h is increased due to the interference, and outputs from the light receiving sections 19e-19h are increased.

On the other hand, if the phase difference between the disturbance light and the optical spots 17b and 17c is brought closer to π, the light intensity on the light receiving sections 19e-19h is decreased due to the interference, and outputs from the light receiving sections 19e-19h are decreased. Therefore, a disturbance is generated on a push-pull signal by the sub-beams, and further, on a differential push-pull signal, and then the recording and reproducing cannot be performed properly.

An observation example of the push-pull signal for the optical recording medium having two recording layers when using a related optical head device is shown in each of FIGS. 14A and 14B. FIG. 14A shows a push-pull signal by a main beam and sub-beams at a layer being nearer to an objective lens, and FIG. 14B shows a push-pull signal by a main beam and sub-beams at a layer being farther from the objective lens. From the drawings, it is found that the disturbance is generated on a push-pull signal by the sub-beams.

For reducing the disturbance to be generated on the differential push-pull signal, required is to increase a ratio of the light amount of optical spots 17b and 17c of the sub-beams to the light amount of the optical spot 18 of the main beam, and suppress the change in light intensity on the light receiving sections 19e-19h due to the interference of the disturbance light and the optical spots 17b and 17c. However, when the ratio of the light amount of the sub-beams to the light amount of the main beam is increased, it happens that recording of data cannot be performed because of the shortage of the light amount of the main beam, or, the data is erased mistakenly by the sub-beams on recording the data by the main beam. Therefore the ratio of the light amount of the sub-beams to the light amount of the main beam is set to be a small value ordinarily, such as about 0.05 to 0.1. As seen above, for the related optical head device which performs recording/reproducing of information on/from the optical recording medium having two recording layers, there is such a problem that, when the differential push-pull method is used for detecting a track error signal, if the interval between the target layer and the non-target layer is changed, the disturbance is generated on the differential push-pull signal, and the recording and reproducing cannot be performed properly.

An exemplary object of the present invention is to provide an optical head device and an optical information recording/reproducing device which can overcome the foregoing issues of the related optical head device that performs recording/reproducing of information on/from the optical recording medium having two recording layers, and which can perform the recording and reproducing of the information without generating the disturbance on the track error signal detected with the differential push-pull method even when the interval between the target layer and the non-target layer is changed.

### Means for Solving the Problems

In order to achieve the foregoing exemplary object, an optical head device according to the invention is a device used for a disk-shaped optical recording medium having two or more recording layers on which an information track is formed, including: alight source; a diffractive optical element which generates a main beam and a sub-beam group from an emitted light beam of the light source; an objective lens which arranges the main beam and the sub-beam group on the optical recording medium; and a photodetector which receives each of a reflected light beam of the main beam and reflected light beams of the sub-beam group from the optical recording medium independently, where the sub-beams of the sub-beam group are Laguerre-Gauss beams.

An optical information recording/reproducing device according to the invention includes the optical head device and a device which calculates a differential push-pull signal that represents a difference between a push-pull signal by the main beam and a push-pull signal by the sub-beam group.

Accordingly, when the interval between the target layer and the non-target layer is changed and the phase difference between the reflected light beam of the sub-beam from the target layer and the disturbance light is changed, an area in which the phase difference is brought closer to zero and the light intensity is increased and an area in which the phase difference is brought closer to π and the light intensity is decreased are weaved consistently on the light receiving section which receives the reflected light beams of the sub-beams from the target layer. As a result, the differences in light intensity due to the interference are averaged, and the output of the light receiving section is hardly changed. Consequently, the disturbance is not generated on the push-pull signal by the sub-beams and further the differential push-pull signal, and the recording and reproducing can be performed properly.

### Effects of the Invention

According to the present invention, the recording and reproducing of the information on/from the optical recording medium having two recording layers can be performed properly, without generating the disturbance on the track error signal detected with the differential push-pull method even when the interval between the target layer and the non-target layer is changed. The reason is, even when the interval between the target layer and the non-target layer is changed and the phase difference between the reflected light beams of the sub-beams from the target layer and the disturbance light is changed, since the sub beams are Laguerre-Gauss beams, the differences in light intensity due to the interference are averaged, and the output of the light receiving section which receives the reflected light beams of the sub-beams from the target layer is hardly changed.

### BEST MODE FOR CARRYING OUT THE INVENTION

Exemplary embodiments of the invention will be described hereinafter by referring to the accompanying drawings.

### First Exemplary Embodiment

An optical head device according to the first exemplary embodiment is configured such that a diffractive optical element 3d of a related optical head device shown in FIG. 10 is replaced with a diffractive optical element 3a shown in FIG. 1.

The diffractive optical element 3a according to the first exemplary embodiment is configured such that the diffractive grating 20 having a rectangular sectional shape is formed on a surface 21 of a substrate, as shown in FIG. 1. The grooves of the gratings in the diffractive grating 20 is formed substantially in parallel to a direction corresponding to a radial direction of a disk 7, and a pattern of the gratings is in a linear form of a substantially equivalent pitch.

The diffractive optical element 3a according to the first exemplary embodiment is configured such that a phase of a left side diffractive grating 20a and a phase of a right side diffractive grating 20b, with respect to a straight line passing through a center of an incident beam and corresponding to a tangential direction of the disk 7, are relatively shifted by substantially a half cycle.

Specifically, in an upper side of the disk 7 with respect to a straight line passing through a center of an incident beam and corresponding to a radial direction of the disk 7, the phase of the right side diffractive grating 20b is shifted in an upward direction with respect to the phase of the left side diffractive grating 20a, by substantially a half cycle. On the other hand, in a lower side of the disk 7 with respect to a straight line passing through a center of an incident beam and corresponding to a radial direction of the disk 7, the phase of the right side diffractive grating 20b is shifted in a downward direction with respect to the phase of the left side diffractive grating 20a, by substantially a half cycle.

About 87.6% of the light beam making incident on the diffractive optical element 3a transmits therethrough as a zeroth order light beam, and about 5.0% each is diffracted as a positive and a negative first order diffracted light beams. Here, a circle illustrated with a dotted line in the drawing corresponds to an effective diameter 22 of the objective lens 6. In this case, each of the positive and the negative first order diffracted light beams from the diffractive optical element 3a becomes a beam whose phase varies continuously from zero to 2π corresponding to an angle around a phase singularity which is an optical axis, within a cross section perpendicular to the optical axis. A beam as such is called a first order Laguerre-Gauss beam. A phase distribution within the cross section perpendicular to the optical axis of the first order Laguerre-Gauss beam is shown in FIG. 2.

FIG. 3 shows a layout of the light focusing spots on the disk 7. The light focusing spots 16a, 16b, and 16c correspond to the zeroth order light beam, the positive first order diffracted light beam, and the negative first order diffracted light beam from the diffractive optical element 3a, respectively. The light focusing spot 16a of a main beam and the light focusing spots 16b and 16c of sub-beams are converged on a same track 15a. Each of the light focusing spots 16b and 16c has an intensity distribution formed to be a doughnut shape, in which the intensity at a center part is zero.

A pattern of light receiving sections of a photodetector 10 and a layout of optical spots on the photodetector 10 according to the first exemplary embodiment are the same as shown in FIG. 13. The optical spots 17a, 17b, and 17c correspond to the zeroth order light beam, the positive first order diffracted light beam, and the negative first order diffracted light beam from the diffractive optical element 3a, respectively. Here, an optical spot 18 corresponds to the reflected light beam of the main beam from the non-target layer when the disk 7 is the optical recording medium having two recording layers, and a part of the reflected light beam makes incident into the light receiving sections 19e-19h as the disturbance light.

Levels of voltage signals outputted from the light receiving sections 19a-19h are expressed as V19a-V19h, respectively. This time, a push-pull signal by the main beam, a push-pull signal by the sub-beam, and a differential push-pull signal used as a track error signal can be obtained by the same arithmetic operation as described for the related optical head device. The reason why the differential push-pull signal can be obtained when light focusing spots 16a-16c are arranged on a same track is that the phases within the cross section perpendicular to the optical axis of the sub-beam are shifted between the left side and right side of the disk 7 with respect to the straight line passing through the optical axis and corresponding to the tangential direction of the disk 7 by substantially π. Note that a focus error signal can be obtained by an arithmetic operation of (V19a+V19d)−(V19b+V19c) based on the astigmatism method commonly known, and a reproducing signal which is a mark/space signal recorded on the disk 7 can be obtained from a harmonic component of (V19a+V19b+V19c+V19d).

The disturbance light interferes with the optical spot 17b on the light receiving sections 19e and 19f, and the disturbance light interferes with the optical spot 17c on the light receiving sections 19g and 19h.

However, the phase of the optical spot 17b varies from zero to 2π continuously in surfaces of the light receiving sections 19e and 19f, and the phase of the optical spot 17c varies from zero to 2π it continuously in surfaces of the light receiving sections 19g and 19h.

On the other hand, the phase of the disturbance light is substantially constant in the surfaces of the light receiving sections 19e-19h.

Accordingly, even when the interval between the target layer and the non-target layer is changed and the phase difference between the disturbance light and the optical spots 17b and 17c is changed, an area in which the phase difference is brought closer to zero and the light intensity is increased and an area in which the phase difference is brought closer to π and the light intensity is decreased are weaved consistently on the light receiving sections 19e-19h. As a result, the differences in light intensity due to the interference are averaged, and the outputs of the light receiving sections 19e-19h are hardly changed. Consequently, the disturbance is not generated on the push-pull signal according to the sub-beams, and further, on the differential push-pull signal, and then the recording and reproducing can be performed properly.

An observation example of the push-pull signal for the optical recording medium having two recording layers when using the first exemplary embodiment is shown in each of FIGS. 4A and 4B. FIG. 4A shows a push-pull signal by a main beam and sub-beams at a layer being nearer to an objective lens, and FIG. 4B shows a push-pull signal by a main beam and sub-beams at a layer being farther from the objective lens. From the drawings, it is found that the disturbance is not generated on a push-pull signal by the sub-beams.

### Second Exemplary Embodiment

An optical head device according to the second exemplary embodiment is configured such that a diffractive optical element 3d of a related optical head device shown in FIG. 10 is replaced with a diffractive optical element 3b shown in FIG. 5.

The diffractive optical element 3b according to the second exemplary embodiment is configured such that the diffractive grating 20 having a rectangular cross sectional shape is formed on a surface of a substrate 21, as shown in FIG. 5. The grooves of the gratings in the diffractive grating 20 are formed substantially in parallel to a direction corresponding to a radial direction of a disk 7, and a pattern of the gratings is in a linear form of a substantially equivalent pitch.

The diffractive optical element 3b according to the second exemplary embodiment is configured such that a phase of a left side diffractive grating 20a and a phase of a right side diffractive grating 20b, with respect to a straight line passing through a center of an incident beam and corresponding to a tangential direction of the disk 7, are relatively shifted by substantially one cycle. Specifically, in an upper side of the disk 7 with respect to a straight line passing through a center of an incident beam and corresponding to a radial direction of the disk 7, the phase of the right side diffractive grating 20b is shifted in an upward direction with respect to the phase of the left side diffractive grating 20a, by substantially one cycle. On the other hand, in a lower side of the disk 7 with respect to a straight line passing through a center of an incident beam and corresponding to a radial direction of the disk 7, the phase of the right side diffractive grating 20b is shifted in a downward direction with respect to the phase of the left side diffractive grating 20a, by substantially one cycle.

About 87.6% of the light beam making incident on the diffractive optical element 3b transmits therethrough as a zeroth order light beam, and about 5.0% each is diffracted as a positive and a negative first order diffracted light beams. Here, a circle illustrated with a dotted line in the drawing corresponds to an effective diameter 22 of the objective lens 6. In this case, each of the positive and the negative first order diffracted light beams from the diffractive optical element 3b becomes a beam whose phase varies continuously from zero to 4π corresponding to an angle around a phase singularity which is an optical axis, in a cross section perpendicular to the optical axis. The beam as such is called a second order Laguerre-Gauss beam.

A layout of the light focusing spots on the disk 7 according to the second exemplary embodiment is the same as that shown in FIG. 12. The light focusing spots 16a, 16b, and 16c correspond to the zeroth order light beam, the positive first order diffracted light beam, and the negative first order diffracted light beam from the diffractive optical element 3b, respectively. The light focusing spot 16a of the main beam is arranged on a track 15a. On the other hand, the light focusing spot 16d of the sub-beam is arranged on a middle point between the track 15a and a neighboring track 15b located on the right side of the track 15a, and the light focusing spot 16e of the sub-beam is arranged on a middle point between the track 15a and a neighboring track 15c located on the left side of the track 15a. Each of the light focusing spots 16d and 16e has an intensity distribution formed to be a doughnut shape, which is not shown, in which the intensity at a center part is zero.

A pattern of light receiving sections of a photodetector 10 and a layout of optical spots on the photodetector 10 according to the second exemplary embodiment are the same as those shown in FIG. 13. The optical spots 17a, 17b, and 17c correspond to the zeroth order light beam, the positive first order diffracted light beam, and the negative first order diffracted light beam from the diffractive optical element 3b, respectively. Here, an optical spot 18 corresponds to the reflected light beam of the main beam from the non-target layer when the disk 7 is the optical recording medium having two recording layers, and a part of the reflected light beam makes incident into the light receiving sections 19e-19h as the disturbance light.

A push-pull signal by the main beam, a push-pull signal by the sub-beam, and a differential push-pull signal used as a track error signal can be obtained by the same arithmetic operation as described for the related optical head device. The reason why the differential push-pull signal can be obtained when the light focusing spots 16d and 16e are arranged so as to be shifted by a half a track pitch with respect to the light focusing spot 16a is that the phases within the cross section perpendicular to the optical axis of the sub-beam are shifted between the left side and right side of the disk 7 with respect to the straight line passing through the optical axis and corresponding to the tangential direction of the disk 7 by substantially 2π. Note that a focus error signal and a reproducing signal can be obtained by the same arithmetic operation described in the first exemplary embodiment.

The disturbance light interferes with the optical spot 17b on the light receiving sections 19e and 19f, and the disturbance light interferes with the optical spot 17c on the light receiving sections 19g and 19h.

However, the phase of the optical spot 17b varies from zero to 4π continuously in surfaces of the light receiving sections 19e and 19f, and the phase of the optical spot 17c varies from zero to 4π continuously in surfaces of the light receiving sections 19g and 19h.

On the other hand, the phase of the disturbance light is substantially constant in the surfaces of the light receiving sections 19e-19h.

Accordingly, when the interval between the target layer and the non-target layer is changed and the phase difference between the disturbance light and the optical spots 17b and 17c is changed, an area in which the phase difference is brought closer to zero and the light intensity is increased and an area in which the phase difference is brought closer to π and the light intensity is decreased are weaved consistently on the light receiving sections 19e-19h. As a result, the differences in light intensity due to the interference are averaged, and the outputs of the light receiving sections 19e-19h are hardly changed. Consequently, the disturbance is not generated on the push-pull signal by the sub-beams, and further, on the differential push-pull signal, and thus the recording and reproducing can be performed properly.

An exemplary embodiment of the optical head device according to the invention is possible to be configured such that a diffractive optical element 3d of the related optical head device shown in FIG. 10 is replaced with a diffractive optical element with which each of the positive and the negative first order diffracted light beams becomes a third or higher order Laguerre-Gauss beam. When using a diffractive optical element with which each of the positive and the negative first order diffracted light beams becomes an odd order Laguerre-Gauss beam, the light focusing spot of the zeroth order light beam and the light focusing spots of the positive and the negative first order diffracted light beam are arranged on the same track on the disk, and when using a diffractive optical element with which each of the positive and the negative first order diffracted light beams becomes an even order Laguerre-Gauss beam, the light focusing spots of the positive and the negative first order diffracted light beams are arranged so as to be shifted by half the track pitch with respect to the light focusing spot of the zeroth order light beam on the disk.

### Third Exemplary Embodiment

A configuration of an optical head device according to a third exemplary embodiment is shown in FIG. 6. In FIG. 6, an emitted light beam from a semiconductor laser 1 is collimated by a collimator lens 2, makes incident to a polarizing beam splitter 4 as P-polarized light, almost all of which transmits therethrough, and is divided into three light beams, i.e., a zeroth order light beam as a main beam, and a positive and a negative first order diffracted light beams as sub-beams, by a diffractive optical element 11. The light beams then transmit a quarter wavelength plate 5 to be converted to circularly polarized light from linearly polarized light, and arranged onto a disk 7 by an objective lens 6. The reflected light beam of the main beam and the reflected light beams of sub-beams from the disk 7 transmit the objective lens 6 from an inverse direction, transmit the quarter wavelength plate 5 to be converted from the circularly polarized light to linearly polarized light whose polarizing direction is orthogonal to the outward path, transmit the diffractive optical element 11, make incident on the polarizing beam splitter 4 as S-polarized light, almost all of which are reflected thereby, and transmit through a cylindrical lens 8 and a convex lens 9, to be received by a photodetector 10.

The diffractive optical element 11 of the third exemplary embodiment is the same as that shown in FIG. 1. Also, FIG. 7 shows a sectional view of the diffractive optical element 11.

The diffractive optical element 11 is configured to have such a structure in which a liquid crystal polymer 13 and a filler 14 are sandwiched between a substrate 12a and a substrate 12b, and a diffraction grating having a rectangular cross sectional shape is formed at a boundary surface of the liquid crystal polymer 13 and the filler 14, as shown in FIG. 7.

The liquid crystal polymer 13 exhibits a uniaxis refractive index anisotropy, and the refractive index for an abnormal light component is higher than the refractive index for a normal light component. On the other hand, the refractive index of the filler 14 is equivalent to the refractive index for a normal light component of the liquid crystal polymer 13.

The emitted light beam from the semiconductor laser 1 makes incident into the diffractive optical element 11 as an abnormal light beam with respect to the liquid crystal polymer 13. About 87.6% of the light beam transmits therethrough as a zeroth order light beam, and about 5.0% each is diffracted as a positive and a negative first order diffracted light beam. This time, each of the positive and the negative first order diffracted light beams from the diffractive optical element 11 becomes a beam whose phase is varied continuously from zero to 2π depending on an angle around a phase singularity which is an optical axis, within a cross section perpendicular to the optical axis. The beam as such is called a first order Laguerre-Gauss beam. On the other hand, the reflected light beam from the disk 7 makes incident into the diffractive optical element 11 as the normal light beam with respect to the liquid crystal polymer 13. About 100% of the light beam transmits therethrough as the zeroth order light beam.

A layout of the light focusing spots on the disk 7 according to the third exemplary embodiment is the same as that shown in FIG. 3. The light focusing spots 16a, 16b, and 16c correspond to the zeroth order light beam, the positive first order diffracted light beam, and the negative first order diffracted light beam from the diffractive optical element 11, respectively. The light focusing spot 16a of the main beam and the light focusing spots 16b and 16c of the sub-beams are arranged on a same track 15a. Each of the light focusing spots 16b and 16c has an intensity distribution formed to be a doughnut shape, in which the intensity at a center part is zero.

A pattern of the light receiving sections of a photodetector 10 and a layout of the optical spots on the photodetector 10 according to the third exemplary embodiment are the same as those shown in FIG. 13. The optical spots 17a, 17b, and 17c correspond to the zeroth order light beam, the positive first order diffracted light beam, and the negative first order diffracted light beam from the diffractive optical element 11, respectively. Here, an optical spot 18 corresponds to the reflected light beam of the main beam from the non-target layer when the disk 7 is the optical recording medium having two recording layers, and a part of the reflected light beam makes incident into the light receiving sections 19e-19h as the disturbance light.

A push-pull signal by the main beam, a push-pull signal by the sub-beam, and a differential push-pull signal used as a track error signal can be obtained by the same arithmetic operation as described for the related optical head device. The reason why the differential push-pull signal can be obtained when the light focusing spots 16a-16c are arranged on the same track is that the phases within the cross section perpendicular to the optical axis of the sub-beam are shifted by substantially π between the left side and right side of the disk 7 with respect to the straight line passing through the optical axis and corresponding to the tangential direction of the disk 7. Note that a focus error signal and a reproducing signal can be obtained by the same arithmetic operation described in the first exemplary embodiment.

The disturbance light interferes with the optical spot 17b on the light receiving sections 19e and 19f, and the disturbance light interferes with the optical spot 17c on the light receiving sections 19g and 19h.

However, the phase of the optical spot 17b varies from zero to 2π continuously in surfaces of the light receiving sections 19e and 19f, and the phase of the optical spot 17c varies from zero to 2π continuously in surfaces of the light receiving sections 19g and 19h.

On the other hand, the phase of the disturbance light is substantially constant in the surfaces of the light receiving sections 19e-19h.

Accordingly, when the interval between the target layer and the non-target layer is changed and the phase difference between the disturbance light and the optical spots 17b and 17c is changed, an area in which the phase difference is brought closer to zero and the light intensity is increased and an area in which the phase difference is brought closer to π and the light intensity is decreased are weaved consistently on the light receiving sections 19e-19h. As a result, the differences in light intensity due to the interference are averaged, and the outputs of the light receiving sections 19e-19h are hardly changed. Consequently, the disturbance is not generated on the push-pull signal by the sub-beams, and further, on the differential push-pull signal, and the recording and reproducing can be performed properly.

Each of the positive and the negative first order diffracted light beams from the diffractive optical element is deflected in the tangential direction of the disk 7 by the diffractive optical element and forwarded to an objective lens 6. This time, if a distance from the diffractive optical element to the objective lens 6 is long, optical axis of each of the positive and the negative first order diffracted light beams at making incident into the objective lens 6 doesn't pass a center of the objective lens 6, and shifts in the tangential direction of the disk 7 with respect to the center of the objective lens 6.

Accordingly, when the diffractive optical element 3a shown in FIG. 1 is used, the phase singularity of each of the positive and the negative first order diffracted light beams is not matched with the center of the objective lens 6, and the intensity distribution of the light focusing spot of each of the positive and the negative first order diffracted light beams doesn't form an exact doughnut shape.

However, in the third exemplary embodiment, since the distance from the diffractive optical element 11 to the objective lens 6 can be shortened by using the diffractive optical element 11 provided between the polarization beam splitter 4 and the quarter wavelength plate 5, the phase singularity of each of the positive and the negative first order diffracted light beams matches with the center of the objective lens 6, and the intensity distribution of the light focusing spot of each of the positive and the negative first order diffracted light beams can be formed to be an exact doughnut shape.

### Fourth Exemplary Embodiment

An optical head device according to the fourth exemplary embodiment is configured such that a diffractive optical element 3d of a related optical head device shown in FIG. 10 is replaced with a diffractive optical element 3c shown in FIG. 8.

The diffractive optical element 3c according to the fourth exemplary embodiment is configured such that the diffractive grating 20 having a rectangular cross sectional shape is formed on a surface of a substrate 21, as shown in FIG. 8. The grooves of the gratings in the diffractive grating 20 are formed substantially in parallel to a direction corresponding to a radial direction of a disk 7, and a pattern of the gratings is in a linear form of a substantially equivalent pitch.

The diffractive optical element 3c according to the fourth exemplary embodiment is configured such that a phase of a left side diffractive grating 20a and a phase of a right side diffractive grating 20b, with respect to a straight line passing through a center of an incident beam and corresponding to a tangential direction of the disk 7, are relatively shifted by substantially one cycle, as shown in FIG. 8.

Specifically, the diffractive optical element 3c according to the fourth exemplary embodiment is configured such that, in an area A at a lower side of a first straight line which is separately-placed from a center of an incident beam downwardly by a prescribed distance and corresponding to a radial direction of the disk 7, and in an area B at an upper side of a second straight line which is separately-placed from a center of an incident beam upwardly by a prescribed distance and corresponding to a radial direction of the disk 7, the phase of the right side diffractive grating 20b is shifted in an upward direction with respect to the phase of the left side diffractive grating 20a. Also, in an area C between the first straight line and the second straight line, the phase of the right side diffractive grating 20b is shifted in a downward direction with respect to the phase of the left side diffractive grating 20a. About 87.6% of the light beam making incident on the diffractive optical element 3c transmits therethrough as a zeroth order light beam, and about 5.0% each is diffracted as a positive and a negative first order diffracted light beams.

The positive first order diffracted light beam and the negative first order diffracted light beam from the diffractive optical element 3c are deflected to an upper side and a lower side in the tangential direction of the disk 7 respectively by the diffractive optical element 3c, and forwarded to an objective lens 6. This time, if a distance from the diffractive optical element 3c to the objective lens 6 is long, optical axis of each of the positive first order diffracted light beam and the negative first order diffracted light beam at making incident into the objective lens 6 doesn't pass a center of the objective lens 6, and shifts to an upper side and a lower side in the tangential direction of the disk 7 respectively with respect to the center of the objective lens 6.

Accordingly, when circles corresponding to the effective diameters of the objective lens 6 with respect to the positive first order diffracted light beam and the negative first order diffracted light beam are projected onto the diffractive optical element 3c, centers of the circles are shifted to an upper side and a lower side in the tangential direction of the disk 7 respectively with respect to the optical axis.

Three circles illustrated with dotted lines in the drawing correspond to the effective diameters 22a, 22b, and 22c of the objective lens 6 with respect to the positive first order diffracted light beam, the zeroth order light beam, and the negative first order diffracted light beam. Here, distances from the optical axis to the first straight line and to the second straight line are determined such that the first straight line and the second straight line in the area A and the area B pass through centers of the circles corresponding to the effective diameters 22a and 22c of the objective lens 6 with respect to the positive first order diffracted light beam and the negative first order diffracted light beam, respectively. This time, each of the positive first order diffracted light beam and the negative first order diffracted light beam from the diffractive optical element 3c becomes a beam whose phase varies continuously from zero to 2π depending on an angle around a phase singularity which is a center of each of the circles corresponding to the effective diameters 22a and 22b of the objective lens 6 with respect to the positive first order diffracted light beam and the negative first order diffracted light beam respectively, within a cross section perpendicular to the optical axis. A beam as such is called a first order Laguerre-Gauss beam.

A layout of the light focusing spots on the disk 7 according to the fourth exemplary embodiment is the same as that shown in FIG. 3. The light focusing spots 16a, 16b, and 16c correspond to the zeroth order light beam, the positive first order diffracted light beam, and the negative first order diffracted light beam from the diffractive optical element 3c, respectively. The light focusing spot 16a of the main beam and the light focusing spots 16b and 16c of the sub-beams are arranged on a same track 15a. Each of the light focusing spots 16b and 16c has an intensity distribution formed in a doughnut shape, in which the intensity at a center part is zero.

A pattern of the light receiving sections of a photodetector 10 and a layout of the optical spots on the photodetector 10 according to the fourth exemplary embodiment are the same as those shown in FIG. 13. The optical spots 17a, 17b, and 17c correspond to the zeroth order light beam, the positive first order diffracted light beam, and the negative first order diffracted light beam from the diffractive optical element 3c, respectively. Here, an optical spot 18 corresponds to the reflected light beam of the main beam from the non-target layer when the disk 7 is the optical recording medium having two recording layers, and a part of the reflected light beam makes incident into the light receiving sections 19e-19h as the disturbance light.

A push-pull signal by the main beam, a push-pull signal by the sub-beam, and a differential push-pull signal used as a track error signal can be obtained by the same arithmetic operation as described for the related optical head device. The reason why the differential push-pull signal can be obtained when the light focusing spots 16a-16c are arranged on the same track is that the phases in the cross section perpendicular to the optical axis of the sub-beam are shifted by substantially π between the left side and right side of the disk 7 with respect to the straight line passing through the optical axis and corresponding to the tangential direction of the disk 7. Note that a focus error signal and a reproducing signal can be obtained by the same arithmetic operation described in the first exemplary embodiment.

The disturbance light interferes with the optical spot 17b on the light receiving sections 19e and 19f, and the disturbance light interferes with the optical spot 17c on the light receiving sections 19g and 19h.

However, the phase of the optical spot 17b varies from zero to 2π continuously in surfaces of the light receiving sections 19e and 19f, and the phase of the optical spot 17c varies from zero to 2π continuously in surfaces of the light receiving sections 19g and 19h.

On the other hand, the phase of the disturbance light is substantially constant in the surfaces of the light receiving sections 19e-19h.

Accordingly, when the interval between the target layer and the non-target layer is changed and the phase difference between the disturbance light and the optical spots 17b and 17c is changed, an area in which the phase difference is brought closer to zero and the light intensity is increased and an area in which the phase difference is brought closer to π and the light intensity is decreased are weaved consistently on the light receiving sections 19e-19h. As a result, the differences in light intensity due to the interference are averaged, and the outputs of the light receiving sections 19e-19h are hardly changed. Consequently, the disturbance is not generated on the push-pull signal by the sub-beams, and further, not generated on the differential push-pull signal, and the recording and reproducing can be performed properly.

As described for the third exemplary embodiment, if a distance from the diffractive optical element to the objective lens 6 is long, and when the diffractive optical element 3a shown in FIG. 1 is used, the phase singularity of each of the positive and the negative first order diffracted light beams is not matched with the center of the objective lens 6, and the intensity distribution of the light focusing spot of each of the positive and the negative first order diffracted light beams doesn't form an exact doughnut shape.

However, in the fourth exemplary embodiment, by using the diffractive optical element 3c shown in FIG. 8, the phase singularity of each of the positive and the negative first order diffracted light beams can be matched with the center of the objective lens 6 even if the distance from the diffractive optical element to the objective lens 6 is long, and the intensity distribution of the light focusing spot of each of the positive first order diffracted light and the negative first order diffracted light can be formed in an exact doughnut shape.

### Fifth Exemplary Embodiment

Next, an optical information recording/reproducing device using the optical head device according to the exemplary embodiment is explained as a fifth exemplary embodiment.

The optical information recording/reproducing device according to the fifth exemplary embodiment is realized by adding a controller 20, a modulation circuit 21, a recording signal generating circuit 22, a semiconductor laser driving circuit 23, an amplifying circuit 24, a reproducing signal processing circuit 25, a demodulation circuit 26, an error signal generating circuit 27, and an objective lens driving circuit 28, to the optical head device according to the first exemplary embodiment. The circuits from the modulation circuit 21 to the objective lens driving circuit 28 are controlled by the controller 20.

When data is recorded on the disk 7, the modulation circuit 21 modulates the data to be recorded on the disk 7 in accordance with a modulation rule. The recording signal generating circuit 22 generates a recording signal for driving the semiconductor laser 1 in accordance with a recording strategy based on a signal modulated by the modulation circuit 21. The semiconductor laser driving circuit 23 supplies electric current according to the recording signal to the semiconductor laser 1, based on the recording signal generated in the recording signal generating circuit 22, to drive the semiconductor laser 1. On the other hand, when data is reproduced from the disk 7, the semiconductor laser driving circuit 23 drives the semiconductor laser 1 such that a power of emitted light from the semiconductor laser 1 becomes constant, by supplying constant electric current to the semiconductor laser 1.

The amplifying circuit 24 amplifies a voltage signal outputted from each light receiving section of the photodetector 10. When data is reproduced from the disk 7, the reproducing signal processing circuit 25 performs a generation, a waveform equalization and a binarization of the reproducing signal which is a mark/space signal recorded in the disk 7, based on the voltage signal amplified by the amplifying circuit 24. The demodulation circuit 26 demodulates the signal binarized by the reproducing signal processing circuit 25 in accordance with the demodulation rule. The error signal generating circuit 27 generates a focus error signal and a track error signal for driving the objective lens 6 based on the voltage signal amplified by the amplifying circuit 24. The objective lens driving circuit 28 drives the objective lens 6 by supplying electric current corresponding to the focus error signal and the track error signal to an actuator (not shown), based on the focus error signal and the track error signal generated in the error signal generating circuit 27. Further, the entire optical head device except for the disk 7 is driven in the radical direction of the disk 7 by a positioner which is not shown, and the disk 7 is rotary-driven by a spindle which is not shown.

Also, in the exemplary embodiment of the invention, it is preferable that: the diffractive optical element includes a diffractive grating formed within a plane perpendicular to the axis of the incident light; the grooves of the gratings in the diffractive grating are substantially being parallel to the direction corresponding to the radial direction of the optical recording medium; the phases of the gratings are shifted between one side and other side of the plane divided by a straight line passing through the center of the incident beam and corresponding to the tangential direction of the optical recording medium; and at the same time, the directions of the phase shifts of the gratings are opposite in one side and in other side of the plane divided by a straight line passing through the center of the incident beam and corresponding to the radial direction of the optical recording medium.

Also, in the exemplary embodiment of the invention, it is preferable that: the diffractive optical element includes a diffractive grating formed within a plane perpendicular to the axis of the incident light; the grooves of the grating in the diffractive grating are formed substantially in parallel to the direction corresponding to the radial direction of the optical recording medium; the phases of the gratings are shifted between one side and other side of the plane divided by a straight line passing through the center of the incident beam and corresponding to the tangential direction of the optical recording medium; and the directions of the phase shifts of the gratings are opposite in an inside area which is sandwiched by a first straight line and a second straight line which are symmetrically arranged with respect to the center of the incident beam and corresponding to the radial direction of the optical recording medium, and in other outside area.

Also, it is preferable that the sub-beams of the sub-beam group are odd order Laguerre-Gauss beams, and the light focusing spot of the main beam and the light focusing spots of the sub-beam group formed by the objective lens are arranged on a same information track on the optical recording medium.

Also, it is preferable that the sub-beams of the sub-beam group are even order Laguerre-Gauss beams, and the light focusing spots of the sub-beam group formed by the objective lens are arranged by being shifted with respect to the light focusing spot of the main beam by a half of the pitch of the information track on the optical recording medium.

An exemplary embodiment of the optical information recording/reproducing device according to the invention may be configured to be a form in which a controller, a modulation circuit, a recording signal generating circuit, a semiconductor laser driving circuit, an amplifying circuit, a reproducing signal processing circuit, a demodulation circuit, an error signal generating circuit, and an objective lens driving circuit are added to the optical head device according to the second to fourth exemplary embodiments is considerable.

While the invention has been described with reference to exemplary embodiments (and examples) thereof, the invention is not limited to these embodiments (and examples). Various changes in form and details which are understood by those skilled in the art may be made within the scope of the present invention.

The present application claims priority based on Japanese Patent Application No. 2006-310778 filed on Nov. 16, 2006, the entire disclosure of which is incorporated herein.

### INDUSTRIAL APPLICABILITY

With the present invention, even when the interval between the target layer and the non-target layer is changed, the disturbance is not generated on the track error signal detected with the differential push-pull method, and the recording and reproducing of information can be performed properly with respect to the optical recording medium having two recording layers.

### BRIEF DESCRIPTION OF THE DRAWINGS

FIG. 1 is a plan view showing a diffractive optical element for an optical head device according to a first exemplary embodiment of the invention;

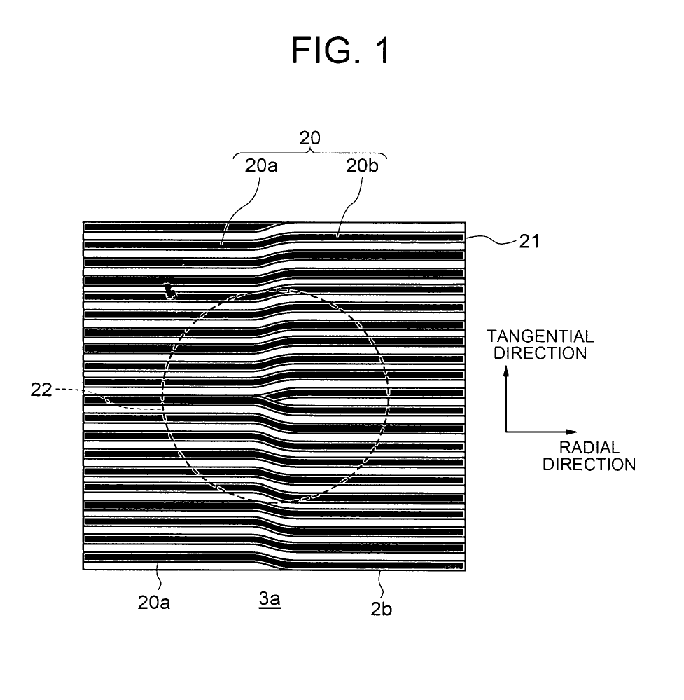

FIG. 2 is an illustration showing a phase distribution within a cross section perpendicular to an axis of a first order Laguerre-Gauss beam;

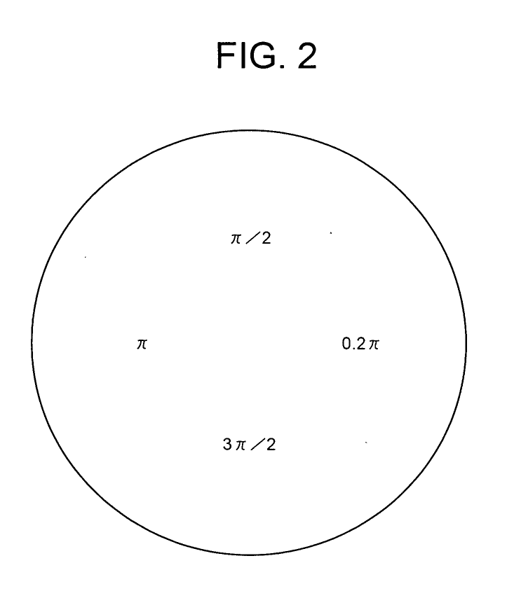

FIG. 3 is an illustration showing a layout of light focusing spots on a disk for the optical head device according to the first exemplary embodiment of the invention;

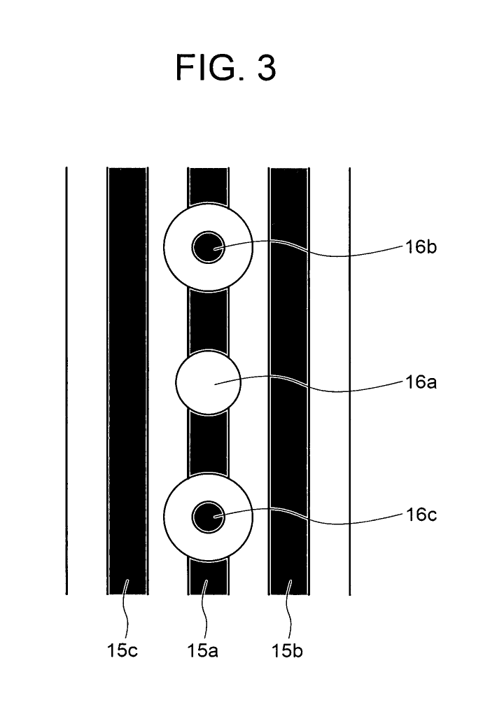

FIGS. 4A and 4B are graphs each of which shows an observation example of a push-pull signal for an optical recording medium having two recording layers when using the optical head device according to a first exemplary embodiment of the invention;

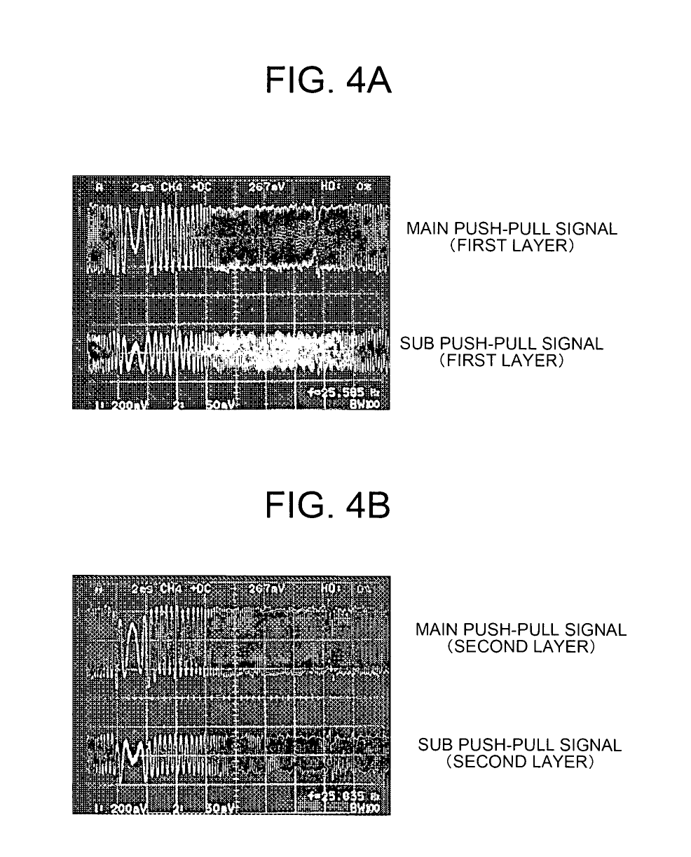

FIG. 5 is a plan view showing a diffractive optical element for an optical head device according to a second exemplary embodiment of the invention;

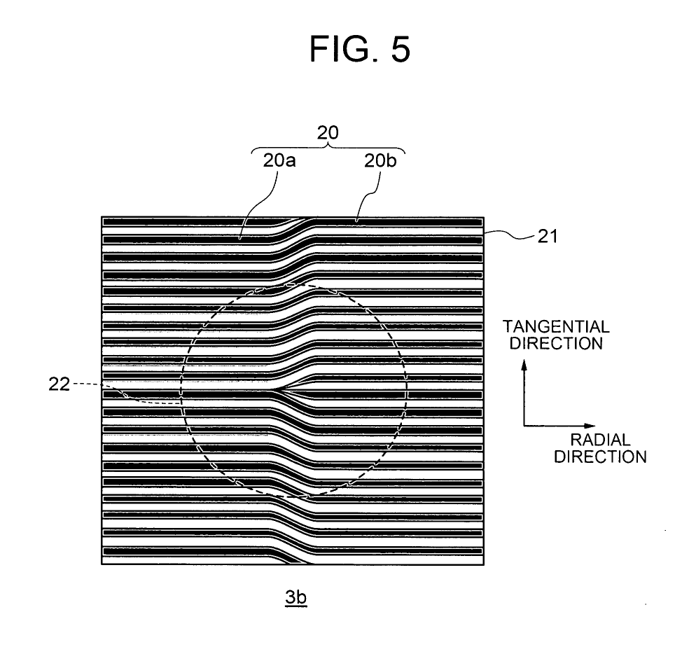

FIG. 6 is an illustration showing an optical head device according to a third exemplary embodiment of the invention;

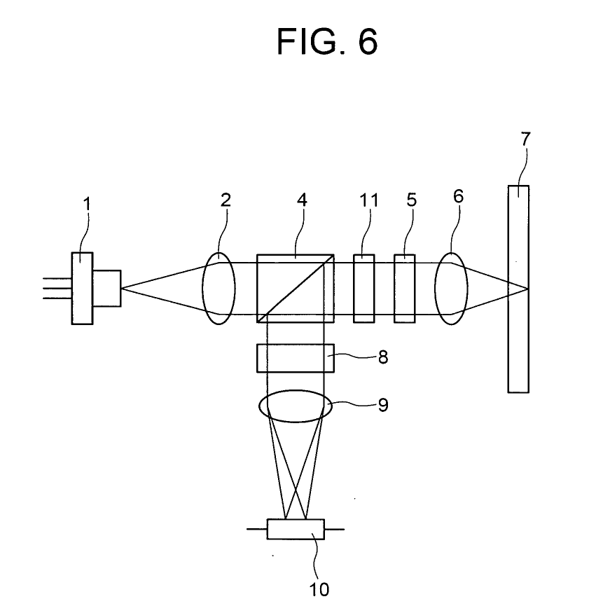

FIG. 7 is a sectional view showing a diffractive optical element for an optical head device according to the third exemplary embodiment of the invention;

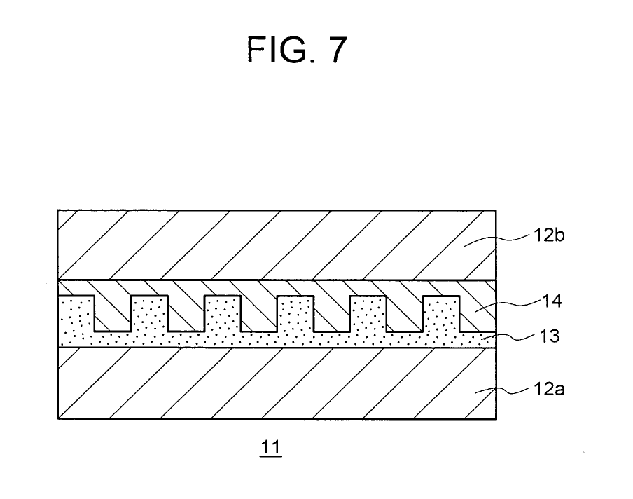

FIG. 8 is a plan view showing a diffractive optical element for an optical head device according to a fourth exemplary embodiment of the invention;

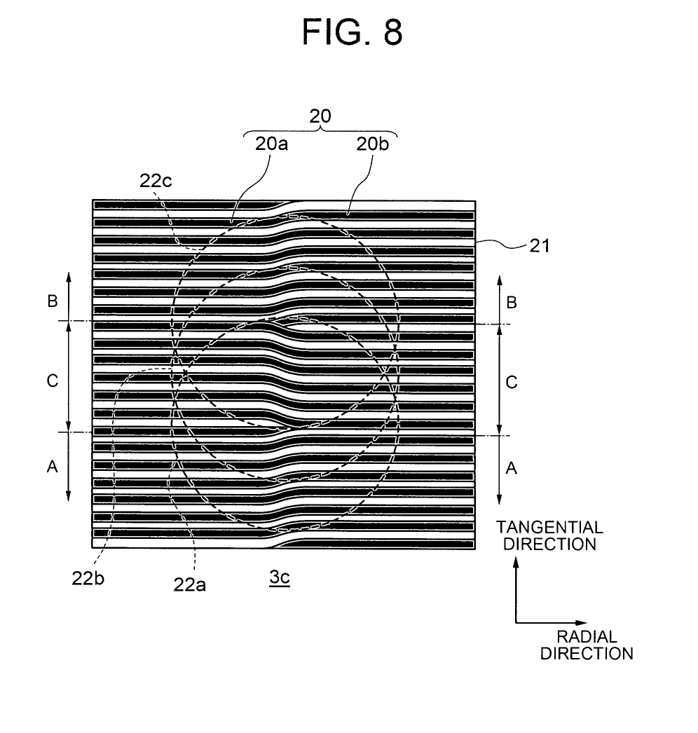

FIG. 9 is an illustration showing an optical information recording/reproducing device using the optical head device according to the first exemplary embodiment of the invention;

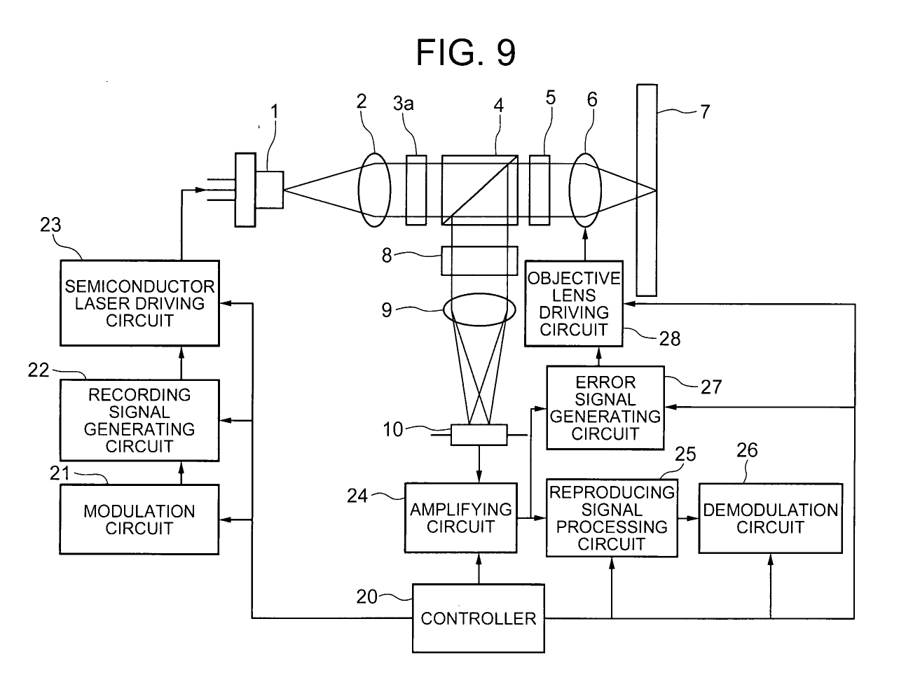

FIG. 10 is an illustration showing a related optical head device;

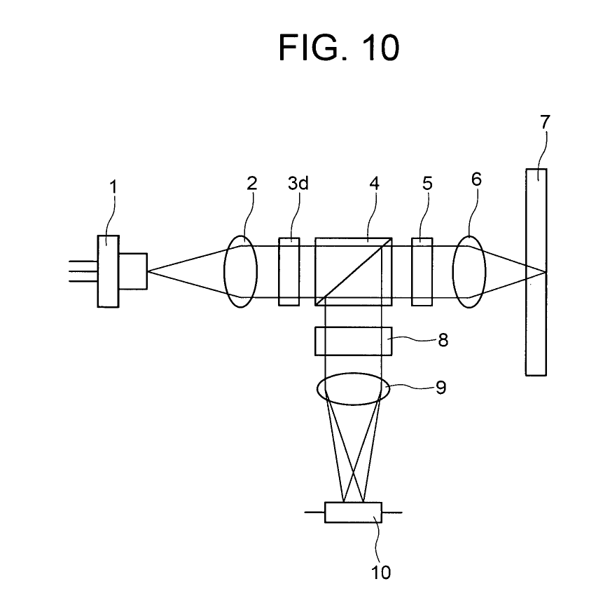

FIG. 11 is a plan view showing a diffractive optical element for the related optical head device;

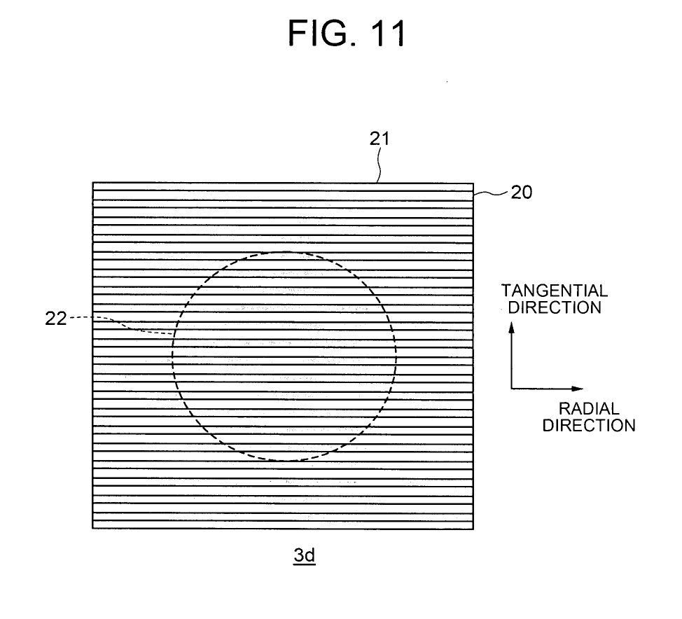

FIG. 12 is an illustration showing a layout of light focusing spots on a disk for the related optical head device;

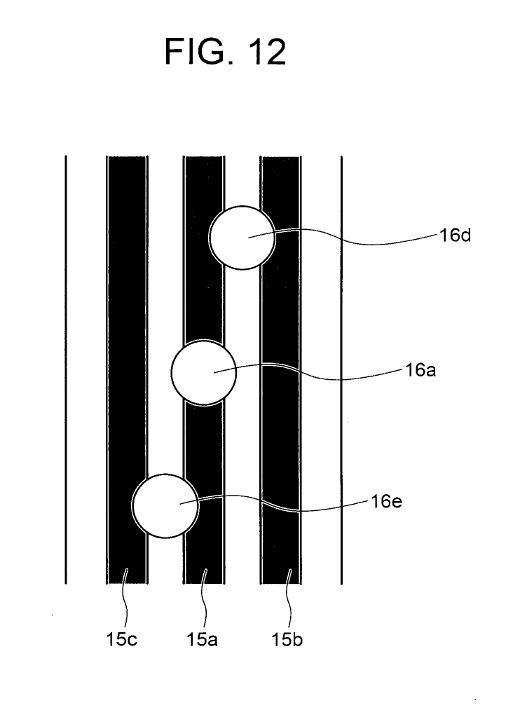

FIG. 13 is an illustration showing a pattern of light receiving sections in the photodetector and a layout of optical spots on the photodetector for the related optical head device; and

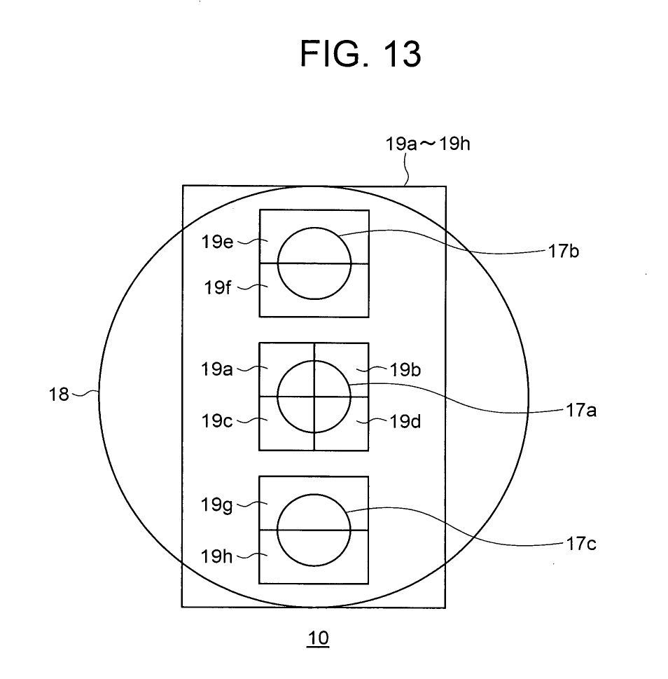

FIGS. 14A and 14B are graphs each of which shows an observation example of a push-pull signal for an optical recording medium having two recording layers when using the related optical head device.

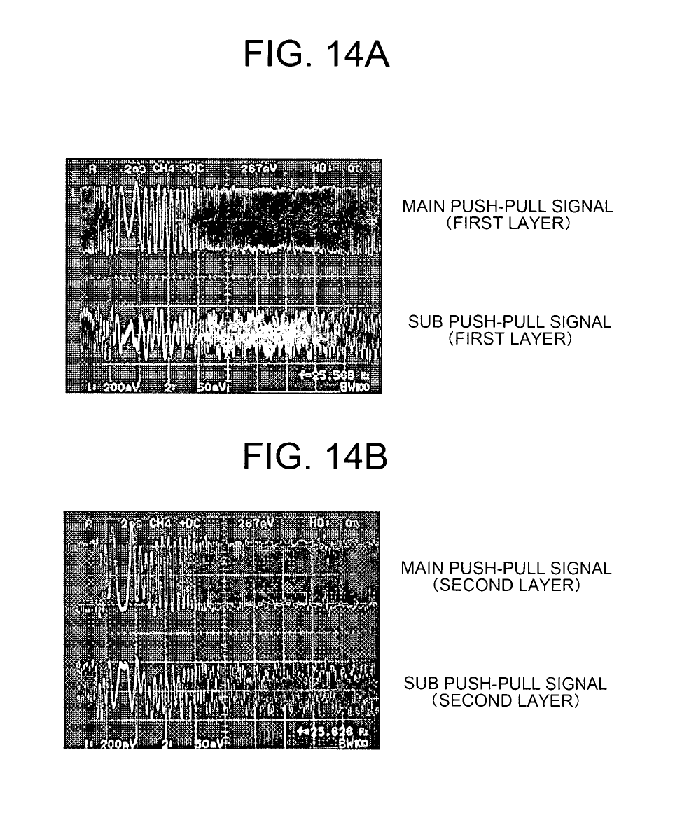

### REFERENCE NUMERALS

1 Semiconductor laser

2 Collimator lens

3a-3d Diffractive optical element

4 Polarization beam splitter

5 Quarter wavelength plate

6 Objective lens

7 Disk

8 Cylindrical lens

9 Convex lens

10 Photodetector

11 Diffractive optical element

12a, 12b Substrate

13 Liquid crystal polymer

14 Filler

15a-15c Track

16a-16e Light focusing spot

17a-17c Optical spot

18 Optical spot

19a-19h Light receiving section

20 Controller

21 Modulation circuit

22 Recording signal generating circuit

23 Semiconductor laser driving circuit

24 Amplifying circuit

25 Reproducing signal processing circuit

26 Demodulation circuit

27 Error signal generating circuit

28 Objective lens driving circuit

1. An optical head device used for a disk-shaped optical recording medium having two or more recording layers on which an information track is formed, comprising:
a diffractive optical element which generates a main beam and a sub-beam group from an emitted light beam of a light source;
an objective lens which converges the main beam and the sub-beam group on the optical recording medium; and
a photodetector which receives each of a reflected light beam of the main beam and reflected light beams of the sub-beam group from the optical recording medium independently, wherein
the sub-beams of the sub-beam group are Laguerre-Gauss beams.

2. The optical head device as claimed in claim 1, wherein
the diffractive optical element includes a diffractive grating formed within a plane perpendicular to an axis of an incident light beam;
grooves of the gratings in the diffractive grating are substantially being in parallel to a direction corresponding to a radial direction of the optical recording medium;
phases of the gratings are shifted between one side and other side of the plane divided by a straight line passing through a center of the incident beam and corresponding to a tangential direction of the optical recording medium; and
directions of phase shifts of the gratings are opposite in one side and in other side of the plane divided by a straight line passing through the center of the incident beam and corresponding to the radial direction of the optical recording medium.

3. The optical head device as claimed in claim 1, wherein
the diffractive optical element includes a diffractive grating formed within a plane perpendicular to an axis of the incident light;
grooves of the gratings in the diffractive grating are substantially being in parallel to a direction corresponding to the radial direction of the optical recording medium;
phases of the gratings are shifted between one side and other side of the plane divided by a straight line passing through a center of the incident beam and corresponding to the tangential direction of the optical recording medium; and
a direction of a phase shift of the gratings in an inside area which is sandwiched by a first straight line and a second straight line which are symmetrically arranged with respect to the center of the incident beam and corresponding to the radial direction of the optical recording medium, is opposite to a direction of a phase shift of the gratings in other outside area.

4. The optical head device as claimed in claim 1, wherein
sub-beams of the sub-beam group are odd order Laguerre-Gauss beams, and
the light focusing spot of the main beam and the light focusing spots of the sub-beam group formed by the objective lens are arranged on a same information track on the optical recording medium.

5. The optical head device as claimed in claim 1, wherein
sub-beams of the sub-beam group are even order Laguerre-Gauss beams, and
the light focusing spots of the sub-beam group formed by the objective lens are arranged by being shifted with respect to the light focusing spot of the main beam formed by the objective lens by a half of the pitch of the information track on the optical recording medium.

6. An optical information recording/reproducing device comprising an optical head device and an arithmetic device, wherein
the optical head device is used for a disk-shaped optical recording medium having two or more recording layers on which an information track is formed, comprising a light source, a diffractive optical element which generates a main beam and a sub-beam group from an emitted light beam of the light source, an objective lens which converges the main beam and the sub-beam group on the optical recording medium, and a photodetector which receives each of a reflected light beam of the main beam and reflected light beams of the sub-beam group from the optical recording medium independently,
sub-beams of the sub-beam group are Laguerre-Gauss beams, and
the arithmetic device calculates a differential push-pull signal which is a difference between the push-pull signal by the main beam and the push-pull signal by the sub-beam group based on an output of the photodetector.

7. An optical head device used for a disk-shaped optical recording medium having two or more recording layers on which an information track is formed, comprising:
diffractive optical means for generating a main beam and a sub-beam group from an emitted light beam of a light source;
an objective lens which converges the main beam and the sub-beam group on the optical recording medium; and
photodetection means for receiving each of a reflected light beam of the main beam and reflected light beams of the sub-beam group from the optical recording medium independently, wherein
the sub-beams of the sub-beam group are Laguerre-Gauss beams.

8. An optical information recording/reproducing device comprising an optical head device and an arithmetic device, wherein
the optical head device is used for a disk-shaped optical recording medium having two or more recording layers on which an information track is formed, comprising a light source, a diffractive optical means for generating a main beam and a sub-beam group from an emitted light beam of the light source, an objective lens which converges the main beam and the sub-beam group on the optical recording medium, and photodetection means for receiving each of a reflected light beam of the main beam and reflected light beams of the sub-beam group from the optical recording medium independently,
sub-beams of the sub-beam group are Laguerre-Gauss beams, and
the arithmetic device calculates a differential push-pull signal which is a difference between the push-pull signal by the main beam and the push-pull signal by the sub-beam group based on an output of the photodetection means.
